(19) United States
(12) Patent Application Publication
(10) Pub. No.: US 2008/0042110 A1
(43) Pub. Date: Feb. 21, 2008

(54) POLYANILINE/POROUS CARBON COMPOSITE AND ELECTRIC DOUBLE LAYER CAPACITOR USING THE SAME

(75) Inventors: Ayumu Kamakura, Hiratsuka-shi (JP); Tsukasa Maruyama, Hiratsuka-shi (JP)

Correspondence Address: CONNOLLY BOVE LODGE & HUTZ LLP, 1875 EYE STREET, N.W., SUITE 1100, WASHINGTON, DC, 20036, US

(73) Assignee: The Yokohama Rubber Co., Ltd., Tokyo (JP)

(21) Appl. No.: 11/838,986

(22) Filed: Aug. 15, 2007

(30) Foreign Application Priority Data
Aug. 18, 2006 (JP) 2006-223130
Feb. 19, 2007 (JP) 2007-038266

(51) Int. Cl. H01B 1/12

(52) U.S. Cl. 252/511

(57) ABSTRACT

A polyaniline/porous carbon composite composed of a conductive polyaniline or the derivative thereof dispersed, in a doped state, in a non-polar organic solvent and a porous carbonaceous material and an electric double layer capacitor having a superior conductivity and a high electrostatic capacity without using a binder using the same.

The present invention relates to a polyaniline/porous carbon composite and an electric double layer capacitor using the same, more specifically relates to a polyaniline/porous carbon composite capable of providing an electric double layer capacitor having a superior conductivity and a high electrostatic capacity, without using a binder and an electric double layer capacitor using the same.

### BACKGROUND ART

In the past, as a polarizable electrode of an electric double layer capacitor, usually activated carbon or fibrous activated carbon has been used, but the discharge capacity thereof is small, and therefore, there was the problem that, when practically used, long term discharge could not be maintained.

In order to solve such problems, Patent Document 1 and Patent Document 2 propose a polarizable electrode of an electric double layer capacitor formed from a conductive polymer/porous carbon composite by the electrolytic polymerization method and practically use a polyaniline/porous carbon composite as an electrode. According to these proposals, there is the advantage that the electrostatic capacity is larger and the internal resistance becomes smaller, when compared with a conventional polarizable electrode. However, the electrolytic polymerization method has the problem that polymerization over a large area is difficult and not industrially feasible, since the electrode area obtained is limited. Further, Patent Document 3 proposes that a polyaniline/porous carbon composite is obtained by the chemical polymerization of aniline in an aqueous solution in the presence of porous carbon and using the resultant composite as a polarizable electrode, but it is necessary to wash the polyaniline/porous carbon composite thus obtained with water, and therefore, there is the problem that the operation becomes troublesome. Further, Patent Document 4 proposes that, after the sulfonated polyaniline and porous carbon material are mixed in water, the mixing solvent, that is, water, is distilled off under vacuum to obtain a polyaniline/porous carbon composite, which is then used as a polarizable electrode. However, since sulfonated polyaniline are water-soluble, and therefore the sulfonated polyaniline is easily eluted from the electrode in the case of a water-based electrolytic solution, while, in the case of an organic solvent-based electrolytic solution, the affinity of the electrode with the electrolytic solution is low. Further, the water used at the time of electrode production cannot be completely removed from the electrode, and therefore, there is the problem that the electrode of an electric double layer capacitor using a water-based and organic solvent-based electrolytic solution is inferior in long-term stability. Further, a sulfonated polyaniline has a sulfonic acid group at the side chain thereof, and therefore, there is also the problem that the breakdown voltage of the electrode becomes lower depending upon the selected electrolyte solution.

Further, according to Patent Document 5, it is proposed to mix the dedoped state polyaniline (emeraldine base form of polyaniline) soluble in N-methyl-2-pyrrolidinone (NMP) and a porous carbonaceous material in NMP, then the NMP is removed so as to obtain the dedoped polyaniline/porous carbon composite, which is used as the polarizable electrode. However, since the dedoped state polyaniline is nonconductive, the internal resistance of the electrode is increased and therefore, the improvement in the electrostatic capacity were difficult. Therefore, according to Patent Document 6, it is proposed to impart conductivity by doping an electrode formed from the dedoped polyaniline/porous carbon composite, but doping treatment of an electrode is troublesome, and it is difficult to completely make the polyaniline present in the electrode conductive.

On the other hand, fundamentally, in order to form an elecrode active material in a powder state, as an electrode, in the past a binder was necessary and essential. However, since the binder is usually a polymer, which is basically an insulator, and therefore, there was the problem that it increased the internal resistance of the electrode and decreased the electrostatic capacity. To overcome this kind of problem, a conductive binder using a conductive polymer has been proposed. For example, Patent Document 4 proposes the use of a sulfonated polyaniline, and Patent Document 5 discloses the use of a conductive polymer dissolved in a solvent as conductive binder, but there is the above-mentioned problem. Further, Patent Document 6 proposes doping an electrode using a dedoped state conductive polymer as a binder so as to impart conductivity, then using this as a capacitor electrode. However, as explained above, there were the problems that the doping of an electrode is troublesome, and it is difficult to completely make the polyaniline present in the electrode conductive.

Patent Document 1: Japanese Patent Publication No. (A) 7-201676

Patent Document 2: Japanese Patent Publication No. (A) 2002-25868

Patent Document 3: Japanese Patent Publication No. (A) 2002-25865

Patent Document 4: Japanese Patent Publication No. (A) 2003-17370

Patent Document 5: Japanese Patent Publication No. (A) 2003-92104

Patent Document 6: Japanese Patent Publication No. (A) 2006-128150

### SUMMARY OF INVENTION

Accordingly, the object of the present invention is to eliminate the above-mentioned problems in the prior art and to more simply obtain a polyaniline/porous carbon composite providing an electric double layer capacitor having a superior conductivity and a high electrostatic capacity, without using a binder in an electric double layer capacitor using a conductive polymer compound, as a polarizable electrode.

In accordance with the present invention, there is provided a polyaniline/porous carbon composite comprising a conductive polyaniline or the derivative thereof dispersed, as a doped state, in a non-polar organic solvent and a porous carbonaceous material and a polarizable electrode and electric double layer capacitor using the same, as an active substance.

In accordance with the present invention, there is provided said polyaniline/porous carbon composite, wherein said conductive polyaniline or the derivative thereof is stably dispersed in a non-polar organic solvent obtained by oxidative polymerization of sulfonic acid and aniline or the derivative thereof in a mixed solvent composed of water and a non-polar organic solvent in the presence of a molecular weight modifier and, optionally, a phase transfer catalyst.

According to the present invention, by using a non-polar organic solvent in which a conductive polyaniline is dispersed in a doped state, it is possible to obtain a composite electrode having a small internal resistance by a simple method, without using a binder.

### BEST MODE FOR CARRYING OUT THE INVENTION

The present inventors engaged in research in order to solve the above-mentioned problems in the art and, as a result, succeeded in achieving the above-mentioned objects by preparing a polyaniline dispersion comprising polyaniline dispersed, in a doped state, in a non-polar organic solvent, a porous carbonaceous material, without using a binder so as to prepare an elecrode active material, and bonding the resultant composite to a current collector to form a polarizable electrode.

In the present invention, it is possible to produce a doped-state polyaniline dispersion in large amounts and efficiently by chemical polymerization of polyaniline in a non-polar organic solvent. Further, it is possible to easily combine the doped-state polyaniline with porous carbonaceous material, without using a binder to form a polyaniline/porous carbon composite.

The present inventors found that conductive polymers do not easily dissolve in solvents in the highly conductive doped state, and therefore, the processability thereof is poor, and further the agglomeration occurs and the uniform mixing thereof with the elecrode active material is impossible, and therefore, the binding power thereof is inferior. The inventors thought that, if it is possible to uniformly mix the conductive polymers, both binding power and electron conductance can be achieved. The inventors discovered that, by using polyaniline dispersed, as a doped state, in a non-polar organic solvent, it is possible to uniformly mix the polyaniline, which is a conductive polymer and elecrode active material by a simple method, whereby the conductive polyaniline or the derivative thereof act as, a binder of an elecrode active material such as a porous carbon material.

The polyaniline or the derivative thereof used in the present invention is usually obtained by oxidative polymerization of aniline or the derivatives thereof or any mixtures thereof. The aniline derivatives are those composed of aniline having at least one alkyl group, alkenyl group, alkoxy group, alkylthio group, aryl group, aryloxy group, alkylaryl group, arylalkyl group, or alkoxyalkyl group as a substituent group at positions other than the 4th position can be exemplified. An aniline derivative having at least one C₁ to C₅ alkyl group, alkoxy group, or alkoxyalkyl group, a C₆ to C₁₀ aryl group, as a substituent group, can be preferably exemplified.

The dopants usable in the present invention may be any organic acid compounds, which can disperse polyaniline in a non-polar solvent. Specifically, they are aliphatic or aromatic sulfonic acids and their salts having one or more sulfonic acid groups. Alkyl sulfonic acids, aryl sulfonic acids, alkylaryl sulfonic acids, α-olefin sulfonic acids, higher aliphatic ester sulfonic acids, (di)alkyl sulfosuccinic acids, sulfonic acids of higher aliphatic amides, camphor sulfonic acids, and their salts may be mentioned. Preferably, dodecylbenzene sulfonic acid, (di)alkyl sulfosuccinic acids and their salts etc. can be mentioned. The amount of these dopants is not particularly limited, but it is preferable to use 0.01 to 5 moles, more preferably 0.1 to 3 moles, based upon 1 mole of aniline or the derivatives thereof.

The oxidizing agent for oxidative polymerization of the aniline is not particularly limited so long as it can polymerize aniline or the derivatives thereof. For example, persulfates such as ammonium persulfate, persulfuric acid, sodium persulfate, potassium persulfate; hydrogen peroxide, ferric chloride, ferric sulfate, potassium dichromate, potassium permanganate, hydrogen peroxide-ferrous salt and other redox initiating agents and the like can be preferably used. These oxidizing agents may be used alone or in any combinations thereof. The amount of these oxidizing agents used is not particularly limited so long as it is an amount sufficient to enable the oxidative polymerization of the aniline or the derivatives thereof, but preferably it is 0.01 to 10 mole, more preferably 0.1 to 5 moles, based upon 1 mole of aniline or the derivatives thereof.

As the molecular weight modifier usable in the present invention, an aniline derivative having a substituent group at the 4th position, a thiol compound, a disulfide compound, and/or an α-methyl-styrene dimer may be mentioned. As the aniline derivative having a substituent group X at the 4th position, a compound having the formula (I) can be mentioned.

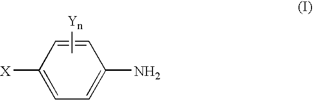

In Formula (I), X represents an alkyl group, alkenyl group, alkoxyl group, alkylthio group, aryl group, aryloxy group, alkylaryl group, arylalkyl group, alkoxyalkyl group or halogen group, Y represents a hydrogen atom, alkyl group, alkenyl group, alkoxy group, alkylthio group, aryl group, aryloxy group, alkylaryl group, arylalkyl group, alkoxyalkyl group or halogen group, n represents an integer from 0 to 4 and, when n is an integer from 2 to 4, Y may be the same or different. The preferable substituent group X is a C₁ to C₅ alkyl group, alkoxy group, alkoxyalkyl group, or C₆ to C₁₀ aryl group and the preferable substituent group Y is a hydrogen atom, C, to C₅ alkyl group, alkoxy group, alkoxyalkyl group or C₆ to C₁₀ aryl group.

As a thiol compound and/or disulfide compound usable in the present invention, thiol compounds such as butyl mercaptan, octyl mercaptan, dodecyl mercaptan, hexadecyl mercaptan, tetradecyl mercaptan, 2,2,4,6,6-pentamethylheptane-4-methylene thiol; alkyl disulfides such as diethyl disulfide, dibutyl disulfide; aromatic disulfides such as diphenyl disulfide, dibenzyl disulfide; xanthogen disulfides such as dimethyl xanthogen disulfide, diethyl xanthogen disulfide; thiuram disulfides such as tetramethyl thiuram disulfide, tetraethyl thiuram disulfide; and other disulfide compounds can be mentioned. These are known compounds. Most of these compounds are generally commercially available. The amount of the molecular weight modifier to be used is not particularly limited, but it is preferable to use 5.0×10⁻⁵ to 5.0×10⁻¹ moles, more preferably 2.0×10⁻⁴ to 2.0×10⁻¹ moles, based upon 1 mole of aniline or its derivatives.

The phase transfer catalyst usable in the preferable aspect of the present invention is not particularly limited so long as it may be generally used as a phase transfer catalyst, but specifically tetraalkylammonium halides such as benzyltriethylammonium chloride, methyltrioctylammonium chloride, tetrabutylammonium bromide, tetrabutylammonium iodide, tetrabutylammonium chloride; tetraalkylammonium hydroxides such as tetrabutylammonium hydroxide; tetraalkylphosphonium halides such as methyltriphenylphosphonium bromide; crown ethers such as 12-crown-4,15-crown-5,18-crown-6; and the like can be mentioned. Among these, from the viewpoint of removal of the catalyst after reaction and other aspects of easy handling, the use of tetraalkylammonium halides is preferred. In particular, the easily industrially available tetrabutylammonium bromide or tetrabutylammonium chloride is preferable. In the present invention, if necessary, while the amount of the phase transfer catalyst used is not particularly limited, it is used in an amount of preferably 0.0001 mole times or more, more preferably 0.005 mole times or more, based upon the oxidizing agent. However, if the phase transfer catalyst is excessively used, the isolation and purification process after the end of the reaction becomes difficult, and therefore, when used, it is preferably used in an amount of 5 moles times or less, more preferably a range of the equimolar amount or less.

Regarding the method of oxidative polymerization of aniline or the derivative thereof according to the present invention, it is possible to employ a conventional method, except that the reactive component is used as an essential requirement. Other generally used additives can be used as in the past, so long as not detracting from the object of the present invention. The polymerization medium of the present invention uses two types of liquid media of water and an organic solvent, as solvents. The organic solvent is not particularly limited so long as it can dissolve aniline or the derivatives thereof and is not water-soluble. As specific examples, aromatic hydrocarbons such as benzene, toluene, xylene; aliphatic hydrocarbons such as hexane, heptane, octane; halogenated hydrocarbons such as dichloroethane, chloroform, 1,2-dichloroethane, chlorobenzene, dichlorobenzene; ethers such as diethyl ether, di-n-propyl ether, diisopropyl ether, di-n-butylether, tert-butylmethyl ether; esters such as ethyl acetate, n-propyl acetate, isopropyl acetate, n-butyl acetate can be mentioned. Among these, preferable solvent are aromatic hydrocarbons, aliphatic hydrocarbons, and halogenated hydrocarbons. Particularly, the inexpensive, low toxicity toluene and xylene are preferable. The above organic solvents may be used alone or in any mixtures thereof. The amount of the liquid medium to be used is the amount which can be stirred. Usually, an amount of 1 to 500 times the weight of the aniline or the derivative thereof is used, preferably 2 to 300 times by the weight. Here, the amount of the organic solvent to be used is 0.05 to 30 times by the weight of the water, preferably 0.1 to 10 times by the weight.

The reaction temperature is not particularly limited, but is preferably −10° C. to 80° C. The yield of the polyaniline oxidatively polymerized according to the present invention is extremely high and is usually 80% or more. The electrical conductivity is 10⁻⁹ Scm⁻¹ or more.

According to the present invention, the polyaniline or the derivative thereof is obtained by chemical polymerization thereof with the dopant (for example, dodecylbenzene sulfonic acid) in a mixed solvent comprising said two types of liquid solvents, that is, water and an organic solvent (for example, toluene or xylene) in the presence of the molecular weight modifier and, if necessary, a phase transfer catalyst. The polyaniline or the derivative thereof thus obtained is stably dispersed as a doped state, in a non-polar organic solvent by the steric effect of the dopant and the affinity of the dopant with a non-polar solvent.

According to the present invention, by mixing the polyaniline or the derivative thereof dispersed, as a doped state, in a non-polar organic solvent with a porous carbonaceous material and drying or filtering and drying the resultant mixture to combine with each other, it is possible to obtain a polyaniline/porous carbon composite.

The method for preparing the polyaniline/porous carbon composite of the present invention is not particularly limited, but the following methods may be mentioned. The method of mixing polyaniline or the derivative thereof dispersed in a non-polar organic solvent, as a doped state, and a porous carbonaceous material and drying or filtering and drying the resultant mixture to obtain a polyaniline/porous carbon composite, the method of mixing polyaniline or the derivative thereof dispersed in a non-polar organic solvent, as a doped state, and a porous carbonaceous material, drying or filtering and drying the resultant mixture, and dispersing the mixture in a solvent, the method of mixing polyaniline or the derivative thereof dispersed in a non-polar organic solvent, as a doped state, and a porous carbonaceous material, and the method of mixing polyaniline or the derivative thereof dispersed in a non-polar organic solvent, as a doped state and a porous carbonaceous material and mixing the mixture and a solvent may be mentioned.

As a mixing means, for example, mixing equipments such as a ball mill, sand mill, beads mill, triple roll mill, high speed disperser, Henschel mixer, planetary ball mill, supersonic disperser, homogenizer, planetary mixer may be mentioned.

The form of the polyaniline/porous carbon composite of the present invention is not particularly limited, but is preferably a powder state or a slurry state dispersed in a solvent.

As a solvent, water; alcohols such as methyl alcohol, ethyl alcohol, propyl alcohol; ketones such as acetone, methylethyl ketone; ethers such as tetrahydrofuran, dioxane, diglyme; amides such as diethyl formamide, dimethyl acetamide, N-methyl-2-pyrrolidone (below sometimes called NMP), dimethyl imidazolidinone; sulfur-based solvents such as dimethyl sulfoxide, sulforane may be mentioned.

As the porous carbonaceous material, the carbonaceous material generally used for an electric double layer capacitor can be used. The preferable required characteristic, is a large specific surface area. Specifically, the material having a specific surface area of 100 m²/g or more is preferable. As specific examples, activated carbon, polyacene, carbon whiskers, graphite, etc. can be mentioned. Powders and fibers of these materials can be used. A preferable porous carbonaceous material is activated carbon. Specifically, activated carbon such as a phenol-based, rayon-based, acrylic-based, pitch-based, coconut husk-based carbon can be mentioned. These porous carbonaceous materials can be used alone or in any combination thereof. When porous carbonaceous materials are used in combination, two or more types of carbonaceous materials having different average particle sizes or particle size distributions may be used in combination. Other porous carbonaceous materials are described in, for example, CMC Publications, “High Capacity Capacitor Technology and Materials”, 1998; Nikkan Kogyo Shimbun, Ltd., “Electric double layer capacitors and Storage Systems”, 1999; B. E. Conway, “Electrochemical Supercapacitors”, Kluwer Academic/Plenum Publishers, NY, 1999. Such porous carbon materials are known and commercially available, for example, from Lion Corporation, as Ketjen Black EC 300J, Ketjen Black EC600JD, from Kurarey Chemical Co., Ltd., as Fine Activated Carbon RP, Fine Activated Carbon YP, and the like.

In a preferred aspect of the present invention, it is possible to obtain a conductive polyaniline/porous carbon composite containing 0.05 to 150 parts by weight of conductive polyaniline or the derivative thereof, preferably 0.5 to 100 parts by weight, based upon 100 parts by weight of the porous carbonaceous material, as a binder of the porous carbonaceous material. If the amount of the conductive polyaniline or the derivative thereof is small, the desired increase in the electrostatic capacitance is difficult, while conversely if large, it may cover the surface of the porous carbonaceous material and decrease the electrostatic capacity.

According to the present invention, it is possible to use an electrode material having the polyaniline/porous carbon composite, as an active substance, to form a polarizable electrode therefrom and a current collector. The current collector is not particularly limited. A known current collector of a usual electric double layer capacitor is preferably used. Metals such as platinum, copper, nickel, aluminum, titanium, nickel; alloys of aluminum etc.; conductive rubber containing carbonaceous materials such as graphite and conductive materials, etc. may be mentioned.

As a specific method for producing a polarizable electrode, for example, when forming the polyaniline/porous carbon composite, as a disk-shaped or sheet-shaped relatively thick electrode, the method of shaping the powder state and/or a solvent-dispersed slurry-state polyaniline/porous carbon composite formed by the above method into the required shape using a tablet making machine or roll press under ordinary temperature or heating can be preferably used. In this case, the current collector and the polyaniline/porous carbon composite electrode may be joined by press bonding, adhesion, or flame spraying.

Further, when forming the polyaniline/porous carbon composite as a relatively thin electrode having a thickness of about 10 to 750 μm or less, the method for coating and drying the solvent-dispersed slurry state polyaniline/porous carbon composite obtained by the above method on the current collector is preferable. Further, it is possible to increase the packing density of the polyaniline/porous carbon composite by drying, then pressing at ordinary temperature or with heating. However, the method for preparing the electrode is not limited to the methods illustrated above. Other methods may also be used.

Further, in the present invention, since the polymer compound, polyaniline, described above is used, a binder is not necessarily required, but it can be used, when preparing the polyaniline/porous carbon composite and/or when preparing the polarizable electrode. The binder, which may be used, is not particularly limited. For example, polyvinylidene fluoride, polytetrafluoroethylene, (poly)vinylidene fluoride-hexafluoropropylene copolymer, polytrifluorochloroethylene, isoprene rubber, butadiene rubber, ethylene-propylene rubber, nitrile rubber, butadiene rubber, chloroprene rubber, acrylonitrile-butadiene-styrene copolymer, polyester, polyamide, polycarbonate, carboxymethyl cellulose, polyvinyl alcohol, (poly)vinylpyrrolidone, poly(meth)acrylic acids and their copolymers, poly(meth)acrylic acid esters and their copolymers, polyimides and the like may be mentioned.

Further, in the present invention, since the polyaniline to be composited with the porous carbonaceous material is a conductive polyaniline, a conductivity agent is not necessarily required, but it may be used, when preparing the polyaniline/porous carbon composite and/or when preparing the polarizable electrode. The usable conductive material is not particularly limited. For example, carbon black, natural graphite, artificial graphite, carbon fiber, metal fiber, titanium oxide, ruthenium oxide and the like may be used. In particular, one type of carbon black, that is, Ketjen Black, acetylene black, etc. or one type of carbon fiber, that is, vapor grown carbon fiber (Showa Denko K.K, trade name VGCF), carbon nanotubes (GSI Creos Corporation, trade name Carbere), or the like are preferable because they provide large effects even in small amounts.

According to the present invention, as explained above, it is possible to obtain an electric double layer capacitor having a high conductivity and a high electrostatic capacity. The polarizable electrode and electric double layer capacitor can be prepared by a general method, other than using a polyaniline/porous carbon composite of the present invention.

### EXAMPLES

The present invention will now be further described by Examples, but the scope of the present invention is not limited to these Examples.

### Examples 1 to 3 and Comparative Examples 1 to 4

### Preparation of Polyaniline/Toluene Dispersion

3 g of aniline, 6.3 g of dodecylbenzene sulfonic acid, and 0.15 g of 2,4,6-trimethyl aniline were dissolved in 150 g of toluene, then 75 g of distilled water, in which 5.36 ml of 6N hydrochloric acid was dissolved, was added. 0.9 g of tetrabutylammonium bromide was added to the resultant mixed solvent, the mixture was cooled to 5° C. or less, then 45 g of distilled water, in which 8.1 g of ammonium persulfate was dissolved, was added. Oxidative polymerization was performed in a state of 5° C. or less for 6 hours, then 100 g of toluene, then a methanol/water mixed solvent (methanol:water=2:3 (weight ratio)) was added and the resultant mixture was stirred. After the end of stirring, the reaction solution separated into a toluene layer and an aqueous layer. Only the aqueous layer was removed to obtain a polyaniline/toluene dispersion. A part of the polyaniline/toluene dispersion was sampled and the toluene was distilled off under vacuum, whereupon the dispersion having a solid content of 3.1% by weight (polyaniline content 1.2% by weight). Further, this dispersion was filtered by a filter of a 1.0 μm pore size, whereupon there was no clogging. Further, even after the dispersion was allowed to stand at room temperature for one year, it remained stable, without agglomeration and precipitation. From elemental analysis, the molar ratio of the dodecylbenzene sulfonic acid based upon the anion monomer unit was 0.45. The yield of the polyaniline thus obtained was 96%.

### Preparation of Polyaniline/Porous Carbon Composite 1

10 g of activated carbon (specific surface area 2000 m²/g, average particle size 10 μm) and 32.3 g of a polyaniline/toluene dispersion (conductive polyaniline 1 g) was mixed with stirring for 5 hours, the dispersion was then heated and dried at 120° C. for 5 hours to remove the toluene, whereby the polyaniline/porous carbon composite 1 was obtained.

### Preparation of Polyaniline/Porous Carbon Composite 2

The same method for preparing the polyaniline/porous carbon composite 1 was used, except that the polyaniline/toluene dispersion was changed to 64.5 g (conductive polyaniline 2 g) to thereby obtain the polyaniline/porous carbon composite 2.

### Preparation of Polyaniline/Porous Carbon Composite 3

The same method for preparing the polyaniline/porous carbon composite 1 was used except that the polyaniline/toluene dispersion was changed to 129.0 g (conductive polyaniline 4 g) to thereby obtain the polyaniline/porous carbon composite 3.

### Preparation of Polyaniline/Porous Carbon Composite 4

10 g of activated carbon (specific surface area 2000 m²/g, average particle size 10 μm) and 32.3 g of a polyaniline/toluene dispersion (conductive polyaniline 1 g) were mixed with stirring for 5 hours, the mixture was then dried at 120° C. for 5 hours to obtain a powder state mixture. N-methylpyrolidone was added to the powder thus obtained and kneaded so as to obtain a slurry state polyaniline/porous carbon composite 4.

### Preparation of Polyaniline/Porous Carbon Composite 5

10 g of activated carbon (specific surface area 2000 m²/g, average particle size 10 μm) and 40 g of a sulfonated polyaniline aqueous solution (Mitsubishi Rayon Co., Ltd., 5% by weight aqueous solution, aquaPASS) (sulfonated polyaniline 2 g) were mixed with stirring for 5 hours, the mixture was then heated and dried at 120° C. to remove the water, whereby the polyaniline/porous carbon composite 5 was obtained.

### Preparation of Polyaniline/Porous Carbon Composite 6

10 g of activated carbon (specific surface area 2000 m²/g, average particle size 10 μm), 2 g of emeraldine base type polyaniline (Aldrich Japan K.K., Mw=10,000), and 60 g of N-methyl-2-pyrrolidone (NMP) were mixed with stirring for 5 hours, the mixture was then heated and dried at 120° C. for 5 hours, then dried under vacuum at 120° C. for 1 hour to remove the NMP, whereby the polyaniline/porous carbon composite 6 was obtained.

### Preparation of Polyaniline/Porous Carbon Composite 7

10 g of activated carbon (specific surface area 2000 m²/g, average particle size 10 μm) and 2 g of emeraldine salt type polyaniline (Aldrich Japan K.K., Mw>15,000) were mixed with stirring by a mortar to obtain the polyaniline/porous carbon composite 7.

### Preparation of Porous Carbon Composite 1

10 g of activated carbon (specific surface area 2000 m²/g, average particle size 10 μm), 1 g of a conductivity agent (Lion Corporation, Ketjen Black EC 300J), 1 g of a binder (Aldrich Japan K.K., polyvinylidene fluoride, Mw=530,000), and 50 g of NMP were mixed with stirring for 5 hours, then heated and dried at 120° C. for 5 hours, then dried under vacuum at 120° C. for 1 hour to remove the NMP, whereby a porous carbon composite was obtained.

### Preparation of Porous Carbon Composite 2

10 g of activated carbon (specific surface area 2000 m²/g, average particle size 10 μm), 1 g of a conductivity agent (Lion Corporation, Ketjen Black EC 300J), 1 g of a binder (Aldrich Japan K.K., polyvinylidene fluoride, Mw=530,000), and 50 g of NMP were kneaded to obtain a slurry state porous carbon composite 2.

### Example 1

The powder state polyaniline/porous carbon composite 1 was press molded to a tablet shape using a tablet-molding apparatus (pressure 10 MPa, diameter 10 mm, made by Nippon Bunko Co., Ltd). The shaped article thus obtained was used as both the positive and negative electrodes. A polypropylene separator was arranged between the positive electrode and negative electrode and impregnated with a 2 mol/L sulfuric acid aqueous solution to prepare an electric double layer capacitor. The charging/discharging of this capacitor was measured by using a Hokutou Denko Corporation HJ201B at a constant current of 100 mA/g per electrode active material in current density. The capacitor was charged up to 0.7V and discharged down to 0V. The charging/discharging measurements were carried out at room temperature.

The electrostatic capacity of the capacitor was calculated from the discharge curve between 0.7V and 0V, according to the energy conversion method described in “Electric double layer capacitors and Storage Systems, 3^{rd} edition, Michio Okamura, 2005, Nikkan Kogyo Shimbun” p. 102. The internal resistance r of the capacitor was found from voltage drop immediately after discharge (ir-drop). Further, the cycle characteristic of the capacitor was obtained by repeatedly charging and discharging the capacitor up to 5000 cycles under the above charging/discharging conditions, then calculating the discharge capacity maintenance rate from the discharge capacity after 5000 cycles and the initial discharge capacity from the formula:

Discharge capacity maintenance rate=Discharge capacity after 5000 cycles/Initial discharge capacity×100 (%)

The discharge capacity, internal resistance and cycle characteristic of the capacitor using the polyaniline/porous carbon composite 1 as an electrode are shown in Table I.

### Example 2

Except for using the polyaniline/porous carbon composite 2, instead of the polyaniline/porous carbon composite 1, the same method as Example 1 was used to prepare an electrode of the polyaniline/porous carbon composite 2 and capacitor. The discharge capacity, internal resistance and cycle characteristic of the capacitor are shown in Table I.

### Example 3

Except for using the polyaniline/porous carbon composite 3 instead of the polyaniline/porous carbon composite 1, the same method as Example 1 was used to prepare an electrode of the polyaniline/porous carbon composite 3 and capacitor. The discharge capacity, internal resistance and cycle characteristic of the capacitor are shown in Table I.

### Comparative Example 1

Except for using the polyaniline/porous carbon composite 5 instead of the polyaniline/porous carbon composite 1, the same method as Example 1 was used to prepare an electrode of the polyaniline/porous carbon composite 5 and capacitor. The discharge capacity, internal resistance and cycle characteristic of the capacitor are shown in Table I.

### Comparative Example 2

Except for using the polyaniline/porous carbon composite 6 instead of the polyaniline/porous carbon composite 1, the same method as Example 1 was used to prepare an electrode of the polyaniline/porous carbon composite 6 and capacitor. The discharge capacity, internal resistance and cycle characteristic of the capacitor are shown in Table I.

### Comparative Example 3

The powder state polyaniline/porous carbon composite 7 was attempted to be press molded using a tablet-molding apparatus (pressure 10 MPa, diameter 10 mm, made by Nippon Bunko Co., Ltd), but could not formed into a tablet.

### Comparative Example 4

Except for using a porous carbon composite 1 instead of the polyaniline/porous carbon composite 1, the same method as Example 1 was used to prepare an electrode of the porous carbon composite and capacitor. The discharge capacity, internal resistance and cycle characteristic of the capacitor are shown in Table I.

TABLE I

| | | | Electrostatic | Internal | Cycle |
|---|---|---|---|---|---|
| | | Electrode | capacity | resistance | characteristic |
| | Electrode | moldability | (F/g) | (Ω) | (%) |
| Example 1 | Polyaniline/porous | Press | 38 | 24 | 96 |
| | carbon composite 1 | molding | | | |
| | | possible | | | |
| Example 2 | Polyaniline/porous | Press | 45 | 17 | 97 |
| | carbon composite 2 | molding | | | |
| | | possible | | | |
| Example 3 | Polyaniline/porous | Press | 54 | 12 | 96 |
| | carbon composite 3 | molding | | | |
| | | possible | | | |
| Comparative | Polyaniline/porous | Press | 34 | 25 | 78 |
| Example 1 | carbon composite 5 | molding | | | |
| | | possible | | | |
| Comparative | Polyaniline/porous | Press | 33 | 46 | 93 |
| Example 2 | carbon composite 6 | molding | | | |
| | | possible | | | |
| Comparative | Polyaniline/porous | Press | — | — | — |
| Example 3 | carbon composite 7 | molding not | | | |
| | | possible | | | |
| Comparative | Porous carbon | Press | 24 | 54 | 95 |
| Example 4 | composite 1 | molding | | | |
| | | possible | | | |

### Examples 4 to 7 and Comparative Examples 5 to 8

### Example 4

The powder state polyaniline/porous carbon composite 1 was press molded to a tablet shape using tablet-molding apparatus (pressure 10 MPa, diameter 10 mm, made by Nippon Bunko Co., Ltd). The shaped article thus obtained was used as both the positive and negative electrodes. A polypropylene separator was arranged between the positive electrode and negative electrode and impregnated with a propylene carbonate solution of 1 mol/L [N(C₂H₄)₄]BF₄ to prepare an electric double layer capacitor. The charging/discharging of this capacitor was measured by using a Hokutou Denko Corporation HJ201B at a constant current of 100 mA/g per electrode active material in current density. The capacitor was charged up to 2.7V and discharged down to 0V. The charging/discharging measurements were carried out at room temperature.

The electrostatic capacity of the capacitor was calculated from the discharge curve between 2.7V and 0V according to the energy conversion method described in Nikkan Kogyo Shimbun, “Electric double layer capacitors and Storage Systems”, 3^{rd} edition, 2005, p. 102. The internal resistance r of the capacitor was found from voltage drop immediately after discharge (ir-drop). Further, the cycle characteristic of the capacitor was determined by repeatedly charging and discharging the capacitor up to 5000 cycles under the above charging/discharging conditions, then calculating the discharge capacity maintenance rate from the discharge capacity after 5000 cycles and the initial discharge capacity from the formula:

Discharge capacity maintenance rate=(Discharge capacity after 5000 cycles/Initial discharge capacity)×100 (%)

The discharge capacity, internal resistance and cycle characteristic of the capacitor using the polyaniline/porous carbon composite 1 as an electrode are shown in Table II.

### Example 5

Except for using the polyaniline/porous carbon composite 2, instead of the polyaniline/porous carbon composite 1, the same method as Example 4 was used to prepare an electrode of the polyaniline/porous carbon composite 2 and capacitor. The discharge capacity, internal resistance and cycle characteristic of the capacitor are shown in Table II.

### Example 6

Except for using the polyaniline/porous carbon composite 3, instead of the polyaniline/porous carbon composite 1, the same method as Example 4 was used to prepare an electrode of the polyaniline/porous carbon composite 3 and capacitor. The discharge capacity, internal resistance and cycle characteristic of the capacitor are shown in Table II.

### Example 7

A slurry state polyaniline/porous carbon composite 4 was coated and dried on aluminum foil (thickness 20 μm) using a bar coater method and pressed by a roll press to prepare a molded article. This molded article was punched into 10 mm diameter disk shapes, which were used as the positive and negative electrodes of an electric double layer capacitor. The method of preparation and method of evaluation of the electric double layer capacitor were the same as in Example 4. The discharge capacity, internal resistance and cycle characteristic of the capacitor are shown in Table II.

### Comparative Example 5

Except for using the polyaniline/porous carbon composite 5, instead of the polyaniline/porous carbon composite 1, the same method as Example 4 was used to prepare an electrode of the polyaniline/porous carbon composite 5 and capacitor. The discharge capacity, internal resistance and cycle characteristic of the capacitor are shown in Table II.

### Comparative Example 6

Except for using the polyaniline/porous carbon composite 6, instead of the polyaniline/porous carbon composite 1, the same method as Example 4 was used to prepare an electrode of the polyaniline/porous carbon composite 6 and capacitor. The discharge capacity, internal resistance and cycle characteristic of the capacitor are shown in Table II.

### Comparative Example 7

Except for using the porous carbon composite 1, instead of the polyaniline/porous carbon composite 1, the same method as Example 4 was used to prepare an electrode of the porous carbon composite 1 and capacitor. The discharge capacity, internal resistance and cycle characteristic of the capacitor are shown in Table II.

### Comparative Example 8

Except for using the porous carbon composite 2, instead of the polyaniline/porous carbon composite 4, the same method as Example 7 was used to prepare an electrode of the porous carbon composite 2 and capacitor. The discharge capacity, internal resistance and cycle characteristic of the capacitor are shown in Table II.

TABLE II

| | | | Electrostatic | Internal | Cycle |
|---|---|---|---|---|---|
| | | Electrode | capacity | resistance | characteristic |
| | Electrode | moldability | (F/g) | (Ω) | (%) |
| Example 4 | Polyaniline/porous | Press | 29 | 48 | 96 |
| | carbon composite 1 | molding | | | |
| | | possible | | | |
| Example 5 | Polyaniline/porous | Press | 34 | 35 | 97 |
| | carbon composite 2 | molding | | | |
| | | possible | | | |
| Example 6 | Polyaniline/porous | Press | 42 | 25 | 96 |
| | carbon composite 3 | molding | | | |
| | | possible | | | |
| Example 7 | Polyaniline/porous | Press | 30 | 47 | 97 |
| | carbon composite 4 | molding | | | |
| | | possible | | | |
| Comparative | Polyaniline/porous | Press | 25 | 51 | 82 |
| Example 5 | carbon composite 5 | molding | | | |
| | | possible | | | |
| Comparative | Polyaniline/porous | Press | 24 | 92 | 93 |
| Example 6 | carbon composite 6 | molding | | | |
| | | possible | | | |
| Comparative | Porous carbon | Press | 18 | 110 | 95 |
| Example 7 | composite 1 | molding | | | |
| | | possible | | | |
| Comparative | Porous carbon | Press | 20 | 100 | 96 |
| Example 8 | composite 2 | molding | | | |
| | | possible | | | |

It was learned from the above results that the electric double layer capacitors using polyaniline/porous carbon composites 1 to 4 of the present invention as electrodes (Examples 1 to 7) have smaller internal resistances of the capacitors and larger electrostatic capacities per electrode weight, compared with the electric double layer capacitors using the porous carbon composites 1 and 2 as electrodes(Comparative Examples 4, 7 and 8). Further, it was learned that the electric double layer capacitors using polyaniline/porous carbon composites 1 to 4 of the present invention as electrodes (Examples 1 to 7) have larger electrostatic capacities per electrode weight and better cycle characteristics, compared with the electric double layer capacitors using the polyaniline/porous carbon composites 5 to 7 using sulfonated polyaniline, dedoped state polyaniline powder and doped state polyaniline powder as a binder, as electrodes (Comparative Examples 1 to 3 and 5 to 6).

As explained above, the polyaniline/porous carbon composites 1 to 4 of the present invention can be simply prepared from a conductive polyaniline dispersion and porous carbonaceous material. The electric double layer capacitors using the polyaniline/porous carbon composites 1 to 4 of the present invention, as electrodes, can decrease the internal resistance and improve the electrostatic capacity. From the above results, the conductive polyaniline dispersed in the polyaniline/porous carbon composites 1 to 4 of the present invention are uniformly dispersed, without agglomerating, in the composites and functioned as binder, conductivity agents and electrode active materials.

### INDUSTRIAL APPLICABILITY

As explained above, the polyaniline/porous carbon composite of the present invention can provide an electric double layer capacitor having a superior conductivity and a high electrostatic capacity, without using a binder. For example, it can be suitably used for a memory back-up power source of a cell phone or the like, an emergency power source of a computer or the like, an energy storage device in a solar power generation system or the like, a device for storing regenerative braking energy in an electric-gasoline hybrid automobile or the like.

1. A polyaniline/porous carbon composite comprising a conductive polyaniline or the derivative thereof dispersed, as a doped state, in a non-polar organic solvent and a porous carbonaceous material.

2. A polyaniline/porous carbon composite as claimed in claim 1, wherein said conductive polyaniline or the derivative thereof is stably dispersed within a non-polar organic solvent obtained by oxidative polymerization of sulfonic acid and aniline or the derivative thereof in a mixed solvent composed of water and a non-polar organic solvent in the presence of a molecular weight modifier and, optionally, a phase transfer catalyst.

3. A polyaniline/porous carbon composite as claimed in claim 1, wherein said conductive polyaniline/porous carbon composite is in the form of a powder or a slurry dispersed a solvent.

4. A polyaniline/porous carbon composite as claimed in claim 1, wherein the amount, of the conductive polyaniline or the derivative thereof is 0.05 to 150 parts by weight, based upon 100 parts by weight of the porous carbonaceous material.

5. A polarizable electrode comprising an elecrode active material using, as an active substance, the polyaniline/porous carbon composite according to claim 1 a current collector and, optionally, a binder.

6. An electric double layer capacitor using, as a positive electrode and/or a negative electrode, the polarizable electrode according to claim 5.
